(19) United States
(12) Patent Application Publication
(10) Pub. No.: US 2015/0266408 A1
(43) Pub. Date: Sep. 24, 2015

(54) LIGHTING SYSTEM USING AN ELECTRICALLY CONDUCTIVE POWER STRIP

(71) Applicant: KC HILITES, INC., Williams, AZ (US)

(72) Inventor: Bobby Leang, Westchester, CA (US)

(21) Appl. No.: 14/664,628

(22) Filed: Mar. 20, 2015

Related U.S. Application Data
(60) Provisional application No. 61/968,749, filed on Mar. 21, 2014.

(51) Int. Cl. B60Q 1/00; F21S 8/10

(52) U.S. Cl. CPC B60Q 1/0094; F21S 48/115; F21S 48/215; F21S 48/13; F21S 48/23

(57) ABSTRACT

Systems, devices, and methods are provided for vehicular lighting applications such as lighting during off-road vehicle use. In some example embodiments, these devices include a single power rail used to light one or more lighting pods. The device can be affixed to a vehicle itself or secondary vehicle parts.

### CROSS REFERENCE TO RELATED APPLICATIONS

The present application claims priority to U.S. Provisional Application Ser. No. 61/968,749, filed Mar. 21, 2014, which is hereby incorporated by reference in its entirety and for all purposes.

### FIELD

The subject matter described herein relates generally to systems, devices, and methods for lighting with an electrically conductive power strip.

### BACKGROUND

Lighting systems for vehicles consist generally of lights for the purposes of illuminating the area within or in the immediate proximity of the vehicle at night or during the daytime in the form of daytime running lamps. These lighting systems may include forward lighting (headlights), rear lighting (tail lights), signal lighting (turn signals), lateral lighting (side marker lights), top lighting (clearance lamps), bottom lighting (accent lighting), emergency lighting (hazard lights), and intra-cabin lighting (interior lights) among others. Most vehicles sold today have original equipment manufacturer (OEM) installed lighting with some or all of these lighting systems. As such, for most vehicles the OEM installed lighting is adequate for standard lighting purposes.

In some cases, the OEM installed lighting proves inadequate for a vehicle owner or operator's purposes. One such case is that of off-road driving (or off-roading). Off-roading can take place at dusk or at night in rural areas that are not well lit. If an off-road vehicle has insufficient lighting then this can lead to an increased risk of accident or injury. As a result, a vehicle owner or operator may choose to supplement the OEM installed lighting with additional lighting devices.

One lighting device that is commonly chosen for supplementing OEM installed lighting is referred to as a light bar. Light bars are compact, high intensity illumination devices that include a series of individual lights arranged in close proximity to each other. The individual lights are typically each of the same type, such halogen, H.I.D (High Intensity Discharge), LED (Light Emitting Diode), and others. Light bars can be installed in a wide variety of locations on the vehicle such as roof bars, front end bars, grill installations, and others, and can even be used to replace the OEM installed lighting.

In addition to off-roading, light bars prove desirable for supplementing or replacing OEM installed lighting in many different vehicular and non-vehicular applications including: industrial (e.g., fixed or moveable within factories or manufacturing facilities, etc.), commercial (e.g., accent lighting for displays, fixed lighting within stores, etc.), military and law enforcement, reconnaissance, recreational activities and driving.

Because light bars have a number of lights arranged closely together, and because it is desirable for many light bars to have a low-profile and compact arrangement, supplying power to each individual light can pose challenges. The wiring often takes up significant space, may be complex, and may increase the time required for installation and maintenance when one or more lights fail.

Light bars are distinguishable from other types of lighting that include multiple individual lights, such as track lighting. Track lighting includes multiple individual lights that reside on and can be adjustably moved along a “track” (hence its name), and provides illumination in stationary and sheltered indoor or outdoor environments. Track lighting is typically installed on ceilings and in other overhead areas where space is abundant. Each individual light is often spaced apart from the adjacent lights so that its position on the track can be adjusted in order to customize the lighting for a particular area or function. Track lighting is not subject to the same space and functional constraints as light bars, and thus track lighting design does not carry with it the same challenges as the design of light bar devices.

Thus, needs exist for improved techniques by which to supply power to compact lighting systems such as light bars.

### SUMMARY

Provided herein are embodiments of lighting devices, systems, and methods that provide enhanced illumination capabilities while reducing the time, space, and complexity of maintenance and replacement. These embodiments are described in the context of vehicular use, although they are not limited to such and can, in fact, be used in a number of non-vehicular applications, such as any location in which space is limited and traditionally wired lighting would not fit. The vehicular lighting devices described herein can include modular light pods and related assemblies. Modular light pods can include lighting elements such as LED's, support structures, wiring, PCB's, reflectors, lenses, and other elements. In certain embodiments, the modular light pod can be an assembly that includes all of the elements of a standalone light except for the power source. Modular light pods can be connected to the power source and coupled with a housing. The housing for modular light pods can include a mounting and power connection provided by one or more power strips also housed within the mounting. The configuration of these devices is described in detail by way of various embodiments which are only examples.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is an exploded view depicting an example embodiment of the mounting, light pods, lenses, and bezel.

FIG. 1B is an assembled view depicting an example embodiment of the device fully assembled.

FIG. 1C is an exploded perspective view of an example embodiment from a front-down angle.

FIG. 2A is a close perspective view depicting an example embodiment of the mounting in detail, with the light pods removed for illustrative purposes.

FIG. 2B is a perspective view of an example embodiment of the mounting with the light pods removed.

FIG. 2C is a perspective view depicting the rear of another example embodiment of a mounting.

FIG. 3 is a front view of an example embodiment of the light pod.

FIG. 4 is a view of an example embodiment of the mounting in detail with light pod PCB's in place.

FIG. 5A is a perspective view of an example embodiment with multiple power strips and different light pods.

FIG. 5B is a perspective view of an example embodiment with a disconnected light pod in the foreground.

FIG. 6A is a view of an example embodiment with multiple power strips and a light pod in place.

FIG. 6B is a view of an example embodiment with an end cap removed from the mounting.

FIG. 6C is a close view of an example embodiment with an end cap attached.

FIG. 7A is a top-down view of an example embodiment with different light pods.

FIG. 7B is a back view of an example embodiment.

FIG. 7C is a rear perspective view of an example embodiment.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Provided herein are compact lighting devices to be affixed to a vehicle as well as associated systems and methods. The devices, systems, and methods described herein can be configured to illuminate areas outside a vehicle, generally in the forward direction of the vehicle when it is in normal operation but also the side and rear of the vehicle.

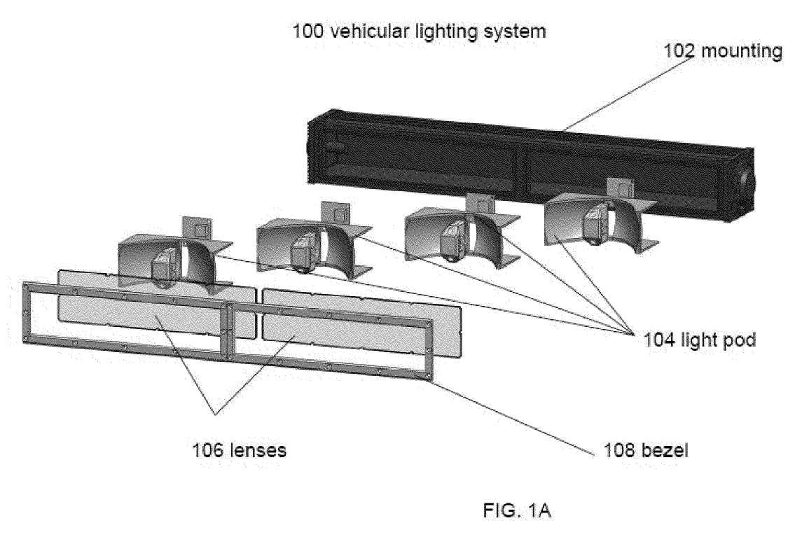

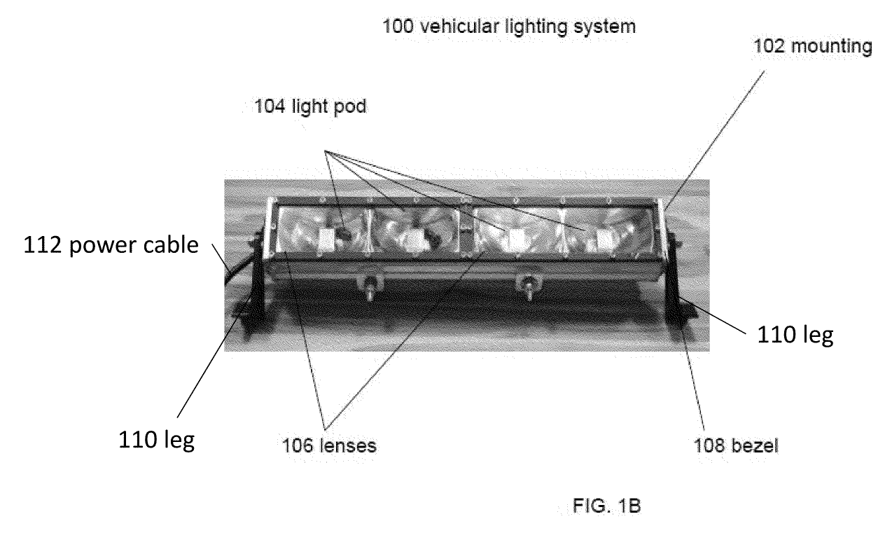

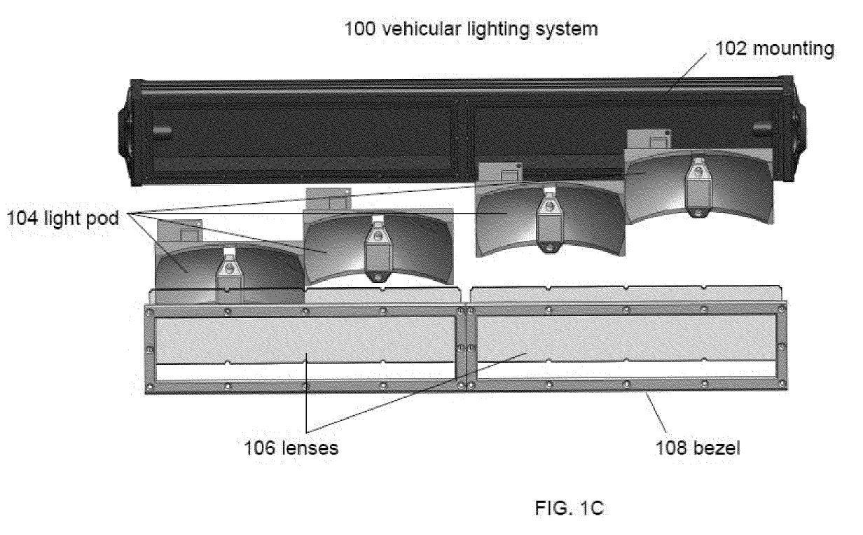

FIG. 1A is an exploded perspective view of a vehicular lighting system 100 having a mounting 102, at least one light pod 104 (there are four in this example), at least one lens 106, and at least one bezel 108. In this example there are four light pods 104, with a lens 106 and one bezel 108 for each pair of light pods 104. It should be noted that each light pod 104 can also have its own lens 106 and bezel 108, and other combinations are permissible. FIG. 1B depicts system 100 in a fully assembled state where light pods 104 are fully contained within the mounting and oriented to direct the light through lenses 106 held in place by the bezel 108. Also shown are mounting legs 110 and power cable 112. FIG. 1C depicts system 100 from a front-down angle.

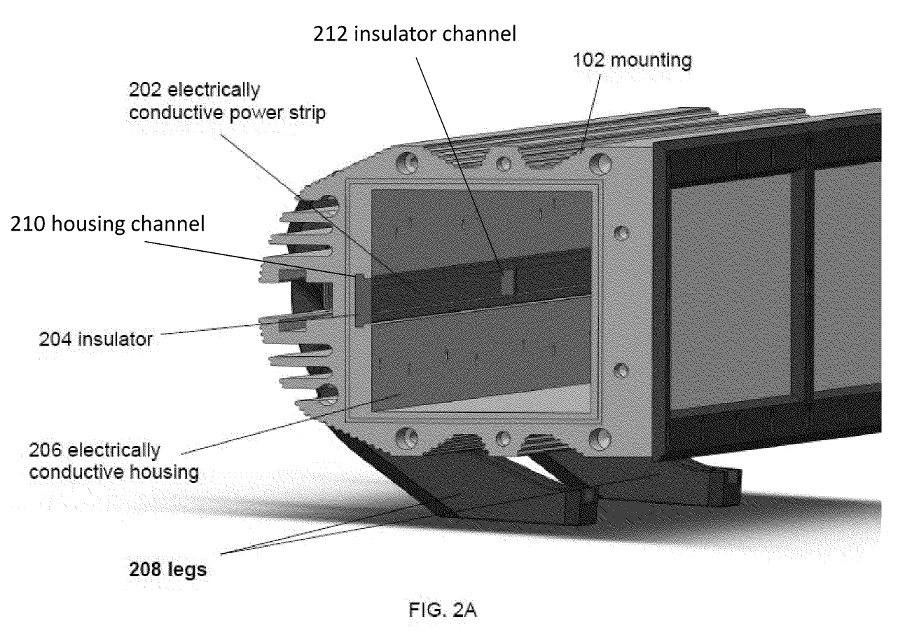

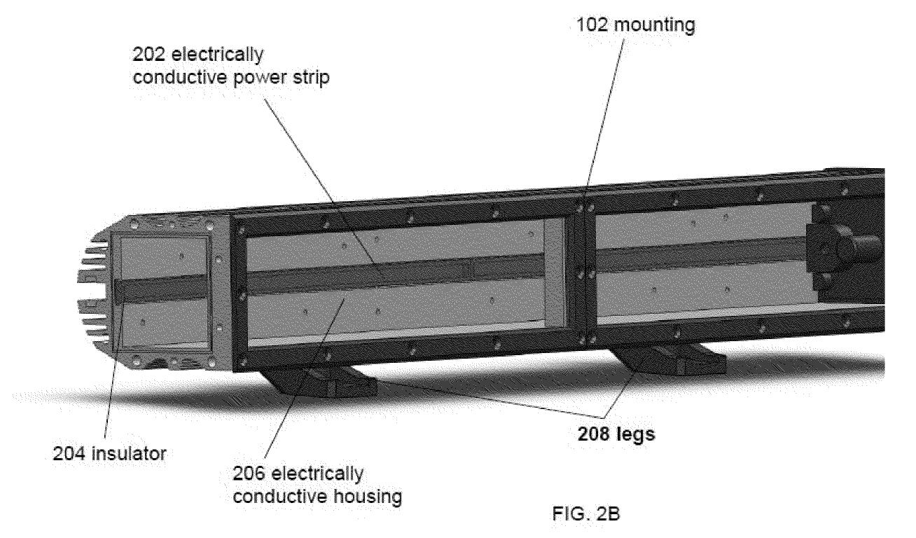

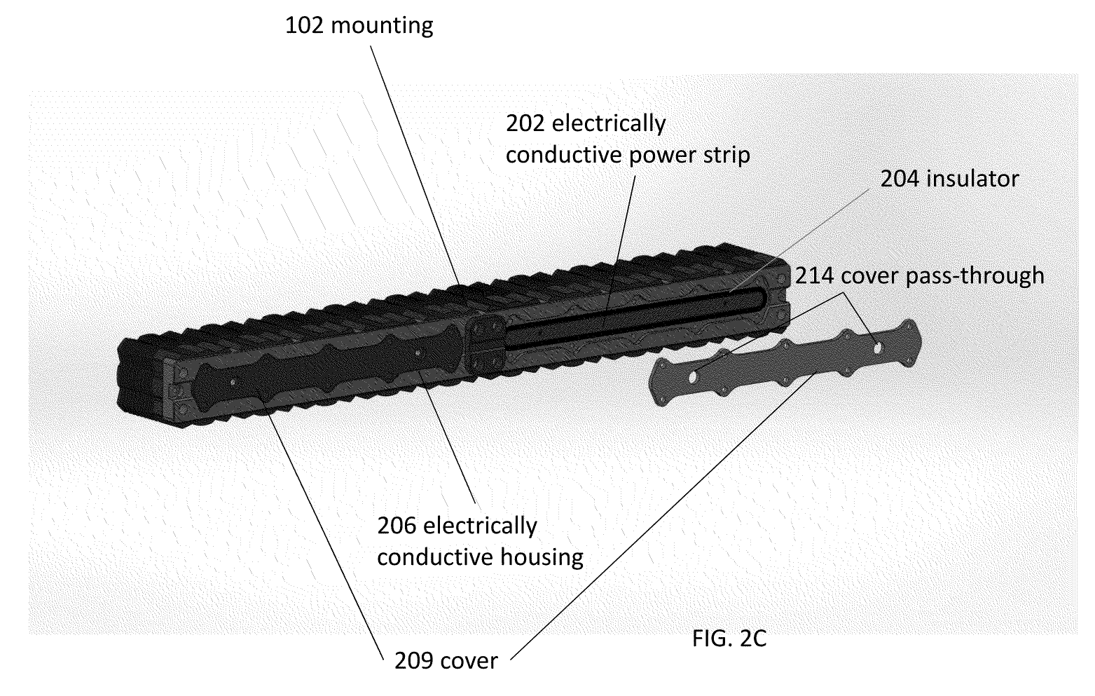

Mounting 102 as further depicted in an example embodiment in FIG. 2A and FIG. 2B includes an electrically conductive power strip 202 insulated from an electrically conductive housing 206 by an insulator 204. Electrically conductive power strip 202 can be made of any material which conducts electricity. In the example embodiment electrically conductive power strip 202 is made of aluminum. Electrically conductive power strip 202 can be continuous or monolithic (or uninterrupted), can run lengthwise along mounting 102, and can terminate at either end prior to or contemporaneous with the end of mounting 102. Multiple power strips 202 can be arranged end-to-end instead of using one continuous power strip 202. Electrically conductive power strip 202 is in electrical communication with one terminal of a power source (not depicted). In many embodiments, electrically conductive housing 206 will be charged opposite from power strip 202 or otherwise connected to a second terminal of a power source (not depicted) and mounting 102 can be connected to ground.

Electrically conductive power strip 202 can be placed on any interior surface of mounting 102 that is convenient to provide power to the light pods 104. The interior surface can be any surface of the cavity in which light pods 104 (not depicted in FIGS. 2A-2C) reside. One interior surface can be the interior surface of mounting 102 facing the same direction in which light pods 104 direct their light. Other interior surfaces include the upper or lower interior surfaces of mounting 102.

In other embodiments electrically conductive power strip 202 can be located on an exterior surface of mounting 102, or at least on a surface other than that of the interior cavity where light pods 104 reside. One such example is depicted in the perspective view of FIG. 2C, where strip 202 is located on an exterior surface of mounting 102. Here, the right side of mounting 102 is shown with power strip 102 prior to being covered with a cover 209 that provides protection from weather and against contact with other objects.

Electrically conductive power strip 202 can have a varying range of dimensions. In a non-limiting embodiment, a power strip 202 has a ⅛″ width. Power strip 202 is electrically insulated from other electrically conductive materials that make up mounting 102 including conductive housing 206. Electrical insulation in some embodiments is accomplished by providing a housing channel 210 in conductive housing 206 of mounting 102 which is lined with an insulator 204 that is interposed between power strip 202 and any other conductive surfaces that power strip 202 may contact. Insulator 204 can be made of electrically insulating material, such as rubber or other insulating material, and electrically conductive power strip 202 can then be inserted in an insulator channel 212 of the insulator 204. Insulator 204 can have a pass-through location through which connection to the power source (not depicted) is possible. Power strip 202 can also have attached insulation along its outward facing surface at predefined locations. For example, front-side insulation can provide predefined pass-through locations for electrical communication of power strip 202 with light pods 104 while otherwise covering the outward facing surface of power strip 202.

Generally, vehicular lighting system 100 can be powered by a battery and thus run on DC power. However, AC power may also be used for power in electrical applications. If required, a power transformer can be included in the form of a master transformer which controls the voltage along electrically conductive power strip 202. Alternatively, each light pod 104 can have its own line-to-low voltage transformer which converts power from electrically conductive power strip 202 to the required end voltage necessary to power the light pod 104. In some embodiments lighting system 100 is powered by a car battery which powers other electrical systems of the vehicle, while in other embodiments a dedicated battery can be used to power only lighting system 100.

Vehicular lighting system 100 receives power from a power source. In order to connect to the power source, vehicular lighting system 100 may require wiring to be connected from mounting 102 to the power source. Connection from mounting 102 to the power source may require modification of the vehicle by means of creating pass-through holes in the structure of the vehicle or it may not require these modifications.

Light pods 104 can be attached to mounting 102 by many different means. The example embodiment shows light pod 104 attached to mounting 102 by means of screws (not labeled). One or multiple or all screws attaching light pod 104 to mounting 102 can be electrically conductive. Some electrically conductive screws can be used appropriately as grounding screws. Some embodiments can use bolts, nuts, and other appropriate hardware to secure light pods 104 in place. In embodiments where screws are not used for electrical connection, appropriate electrical contacts such as conductive pads can provide electrical connection to electrically conductive power strip 202, electrically conductive housing 206, and mounting 102.

Cover 209 can fit into a complementary sized cutout section of mounting 102 and held in place by screws, clips, fasteners, or other appropriate components. In many embodiments cover 209 is an electrical insulator. Cover 209 can have cover pass-through 214 which allows for electrical connection of electrically conductive power strip 202

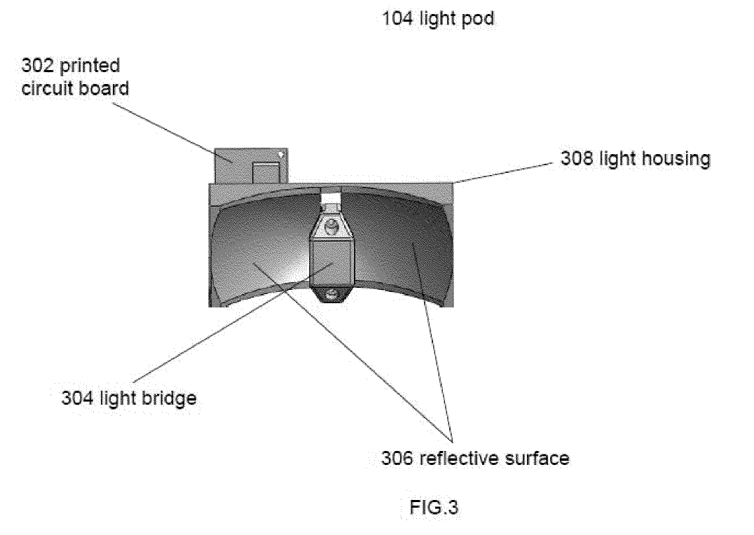

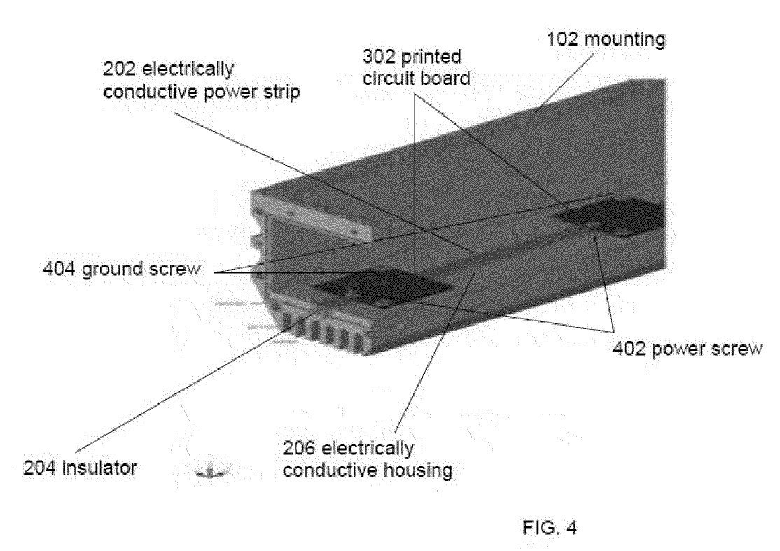

An example embodiment of light pod 104 is depicted in the perspective view of FIG. 3. Light pod 104 can include a printed circuit board 302, light bridge 304, reflective surface 306, and light housing 308. Light housing 308 may be a standalone structure to which printed circuit board 302, light bridge 304, and reflective surface 306 are later attached or any number of these components can be integrated into the structure of light housing 308 during manufacture while others can be later attached during assembly of light pod 104. In some embodiments, some components, such as printed circuit board 302 can be installed in appropriate manner with electrical connections prior to installation of light pod 104 in the overall vehicular lighting system, as shown in FIG. 4.

Printed circuit board 302 of light pod 104 includes a connector which allows for electrical connection with electrically conductive power strip 202. Printed circuit board 302 also provides an electrical connection with light bridge 304. In this example embodiment, printed circuit board 302 of light pod 104 is connected to electrically conductive power strip 202 via an electrically conductive power screw 402. The electrically conductive power screw 402 electrically contacts the positive terminal on printed circuit board 302 and screws directly into an electrically conductive screw hole provided in electrically conductive power strip 202. Likewise, ground screw 404 provides grounding from mounting 102 to electrically conductive housing 308. These arrangements allow an electrical connection to be provided from power strip 202 directly to each light pod 104 without the use of electrical wires (e.g., jacketed wire) that can be space consuming and burdensome to install in the manufacturing process.

Although screws are used as the electrical and primary mechanical connections in this embodiment, other types of electrical connections can also be used (e.g., direct wiring, electrically conductive spring, or others) as both a mechanical and electrical connection or in addition to the primary mechanical connection (e.g., screws, rivets, adhesive, and the like). Printed circuit board 302 can include control circuitry for controlling the lighting of LED's on light bridge 304, such as on and off functionality, different brightness levels as well as any dimming capabilities.

Light bridge 304 can span the entire width of light housing 308, as shown in FIG. 3, or can span only a portion of the width of light housing 308. Although light bridge 304 is depicted as attaching at both a top and bottom location to light housing 308 it can alternately attach to light housing at only one location, either top or bottom, as an arm structure with its end suspended over light housing 308.

Light bridge 304 provides a structure which allows for LED's to be fixed in space above reflective surface 306. LED's can be fixed to light bridge individually in predefined locations or multiple LED's can be fixed in LED modules with predefined patterns and attached to light bridge 304.

Reflective surface 306 in the example embodiment is depicted as having a hollowed partial toroid shape. Different shapes for reflective surface 306 may be appropriate for different applications such as spotlighting, wide range light, and others. In the example embodiment reflective surface 306 is designed specific to the LED configuration to yield a desired beam pattern such as driving, spotlight, floodlight, or certified. Additionally, in some embodiments a multitude of different angular surfaces within the hollowed toroid may be appropriate for sufficiently spreading light from the LED's to the area to be illuminated.

Reflective surface 306 may be any appropriate surface which reflects LED light sufficient for the illumination application desired. As such, various embodiments can use a different reflective surface which can be polished, coated, or treated and can include ridges, ripples, or other features to spread or concentrate light as required for particular applications.

In the example embodiment, system 100 includes translucent or transparent lenses 106 which allow light to travel through from the light pods to the outside environment to be illuminated. Lenses 106 can be made out of any appropriate material including but not limited to polycarbonate. In the example embodiment a polycarbonate sheet is cut to the correct size. Polycarbonate is generally preferred to glass because it provides greater impact resistance and is less prone to breakage. In some embodiments lenses can include internal three-dimensional structures which serve to spread or focus light as appropriate for particular applications.

Lenses 106 can be flush with light pods 104 on one side and bezel 108 on the other which can hold lenses 106 in place. Alternatively, one or more gaskets (not pictured) can be used to hold the lenses 106 in a fixed position between bezel 108 and light pods 104. Combinations of flush on one side and gasket on the other are also contemplated. These gaskets can be made of any appropriate material and can be used on one or both sides of lenses 106.

One or more bezels 108 are provided in order to hold the lenses in place and/or provide a seal on the front of the device. Bezel 108 can be made out of any appropriate material. Bezel 108 can be attached to the mounting by any number of means including screws, clips, fasteners, latches, buckles, clasps, rivets, bolts, snaps, catches, locks, among others. As is understood in the art, for purposes of off-road use, appropriateness of attachment may be determined by an ability to withstand extreme mechanical and environmental stresses.

Mounting 102 may be affixed to a vehicle by any number of appropriate means. This can include a form of legs 208 as shown in FIG. 1B, FIG. 2A and FIG. 2B. Legs 110 and legs 208 may be manufactured as part of mounting 102 in a single structure. Alternatively, legs 208 may be separately manufactured and later attached to mounting 102 by appropriate attachment means. As such, mounting 102 may be affixed in a location so as aim the device in a direction in which the user requires better illumination. This can be achieved by affixing legs 208 directly to the roof of a vehicle. Alternatively, this may be achieved by affixing legs 208 to an installed light mounting bar (not pictured).

A method of manufacturing a lighting device as described above in accordance with the present invention will now be provided. In some embodiments the method includes electrically coupling at least one light pod 104 to an electrically conductive power strip 202 within a mounting 102. In some embodiments light pod 104 can be purchased fully assembled. In some embodiments a user can assemble components of light pod 104.

In some embodiments an insulator 204 can be installed in a housing channel 210 of mounting 102 and an electrically conductive power strip 202 can be installed in insulator channel 212. In other embodiments an electrically conductive power strip 202 can be installed in an insulator channel 212 before an insulator 204 is installed in housing channel 210.

In embodiments where light pod 104 is assembled by a user, the user can attach reflective surface 306 to light housing 308 if it they are not integrated as a single component. Light bridge 304 can be attached by appropriate attachment means such as screws or others.

In some embodiments light bridge 304 may include a metal core printed circuit board (MCPCB) which incorporates a base metal as a heat spreader in order to manage thermal output of the LED(s).

In embodiments where electrically conductive power strip 202 is located on an interior surface of mounting 102, printed circuit board 302 can be electrically coupled by wiring power screw 402 to the appropriate terminal of printed circuit board 302. Likewise, ground screw 404 may be connected to electrically conductive housing 206 and to the appropriate terminal on printed circuit board 302. Additional mounting screws may also be provided.

Printed circuit board 302 and light bridge 304 can be electrically connected by appropriate connection. Light pod 104 can then be fixed to or within mounting 102 by appropriate attachment means such as screws, clips or others. These connections and attachments can be repeated as required for the number of light pod 104's to fill mounting 102. In some embodiments this can be four light pod 104s while in other embodiments more or fewer light pod 104s may be appropriate.

In some embodiments power can be provided to mounting 102 through appropriate means such as a power cable assembly that attaches to a power distribution piece or end cap at the end of mounting 102. In some embodiments power distribution piece or end cap has two terminals to provide power. A connection is then made between electrically conductive power strip 202 and an appropriate terminal and electrically conductive housing 206 and an appropriate terminal.

After light pod 104s are connected or attached to mounting 102, lenses 106 can be attached to mounting 102. In some embodiments lenses 106 can be attached or affixed to light pod 104s before light pod 104s are connected or attached to mounting 102. Bezels 108 can be attached or connected to mounting 102 after lenses 106 are in place.

In many embodiments the lighting system is installed on an appropriate vehicle or attachment as a final step. This can include affixing legs 208 to a roof rack, lighting support structure, or other appropriate support accessory or to the vehicle itself.

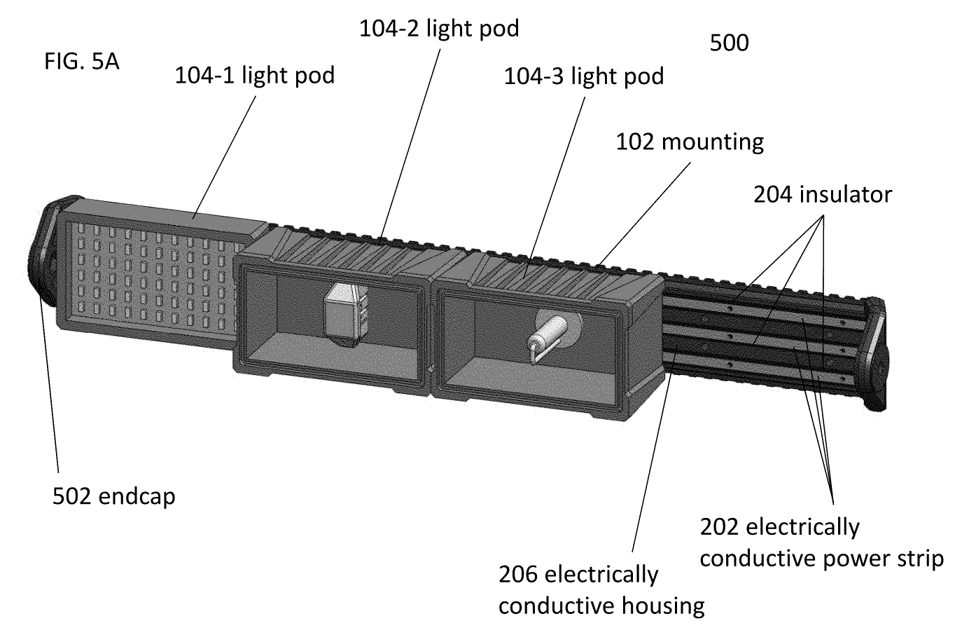

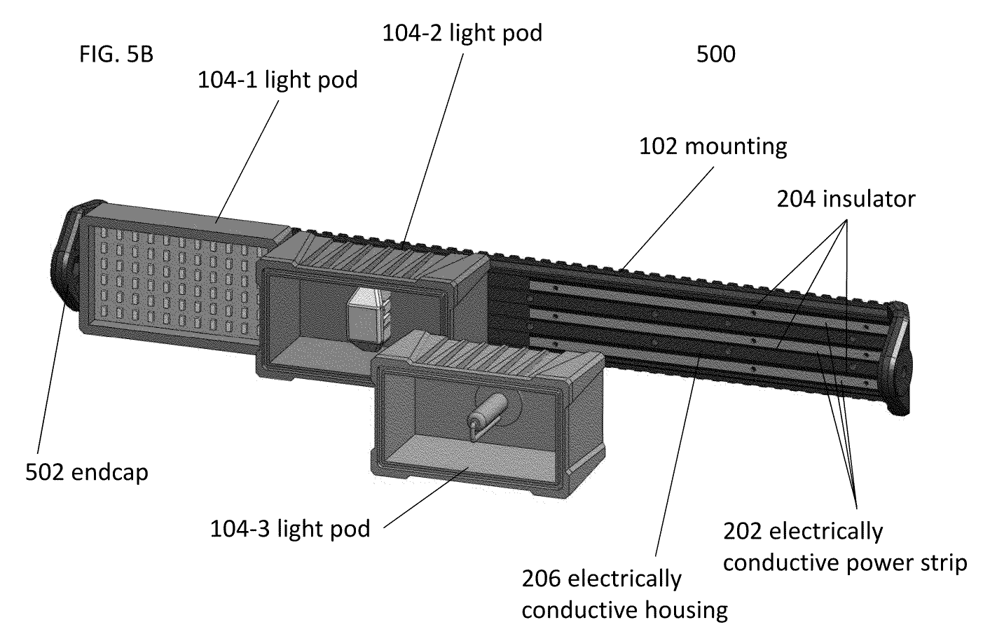

FIG. 5A is a perspective view of an example embodiment of lighting system 500 with multiple power strips 202 and different light pods 104-1, 104-2, and 104-3. In the example embodiment multiple electrically conductive power strips 202 are shown. Electrically conductive power strips 202 are shown in parallel running lengthwise across a forward facing surface of mounting 102. In alternative embodiments one or more electrically conductive power strips can run along a shorter length of the mounting or be oriented differently, such as across the width of the mounting rather than the length as shown. Including multiple electrically conductive power strips 202 enhances the versatility of the lighting system 500. As shown, different types of light pods 104-1, 104-2 and 104-3 can be used together in a lighting system 500. Each light pod 104 can be electrically coupled to a different electrically conductive power strip 202 and as such, each light pod 104 can be independently controlled by an operator through control means such as a connected switch or button.

In the example embodiment, a first light pod 104-1 can be a LED array with multiple LED's arranged in a grid over a forward face of the light pod. Each LED can be individually electrically coupled in parallel or, or alternatively sets or groups can be coupled in series. In some embodiments, light pod 104-1 can be electrically coupled to more than one electrically conductive power strip 202 such that different groups or subsets of LEDs are powered by different electrically conductive power strips 202. In an example embodiment each power strip 202 can be hard wired to an independent rocker switch in a vehicle passenger cabin for control. Power can be provided with a vehicle battery and an auxiliary backup battery.

A second light pod 104-2 can be a light pod as described previously in this application with a light bridge. A third light pod 104-3 can be a high intensity discharge (HID) light pod with a HID structure. As each light pod 104 is independent and self-contained, each light pod 104 can have its own lens and bezel (neither shown). Lenses in the example embodiment can be set into grooves in the light pods 104. Flashing or other specialized functions can be provided with an in-line toggle switch.

FIG. 5B is a perspective view of an example embodiment with a disconnected light pod in the foreground. As shown, mounting 102 in the example embodiment in FIGS. 5A-5B does not have an exterior structure extending at a right angle from the mounting 102 such that light pods 104 are housed inside the mounting. As such, light pods 104 are self-contained and independent. This allows for light pods 104 of different depths to be arranged on a single mounting 102 as shown by the relatively shallow depth of light pod 104-1 compared to the deeper depth of light pods 104-2 and 104-3. As described previously, each electrically conductive power strip 202 can be associated with a related insulator 204 and installed in a channel in mounting 102.

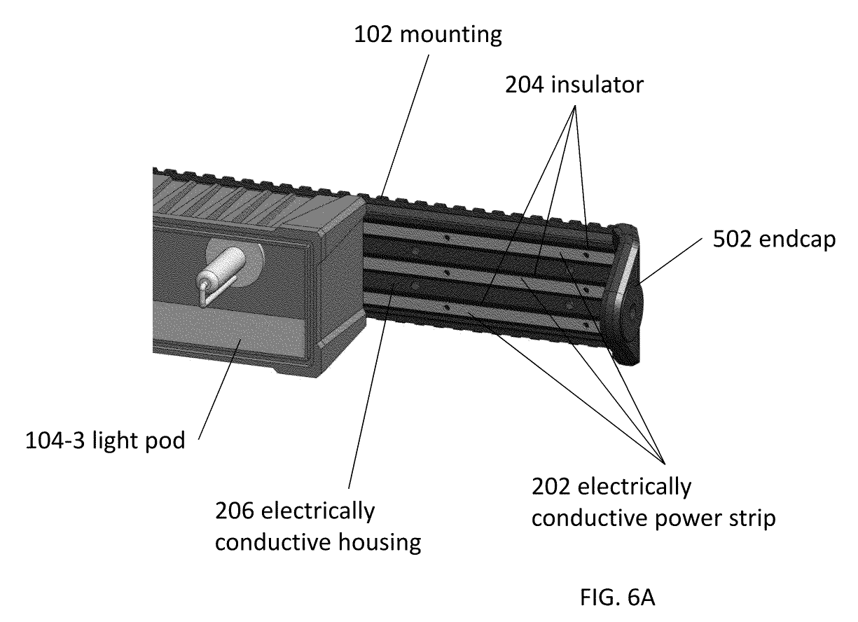

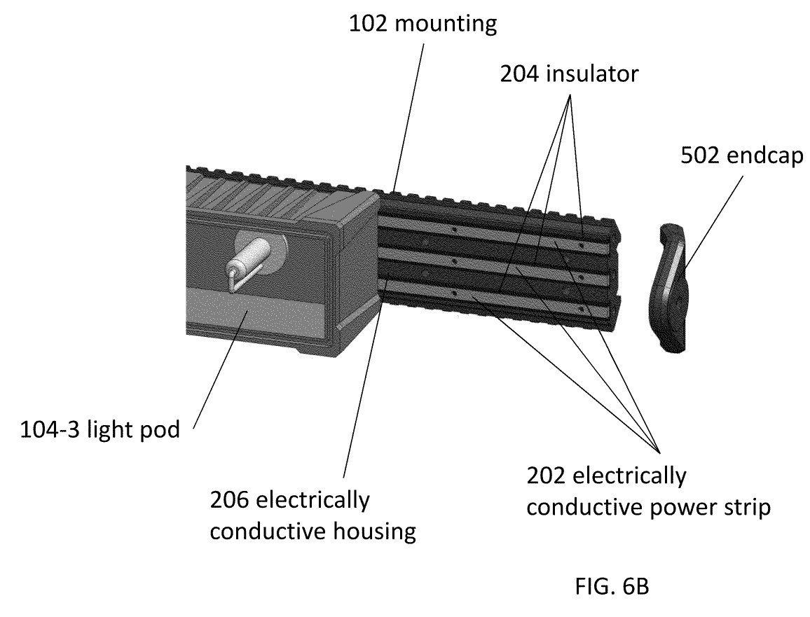

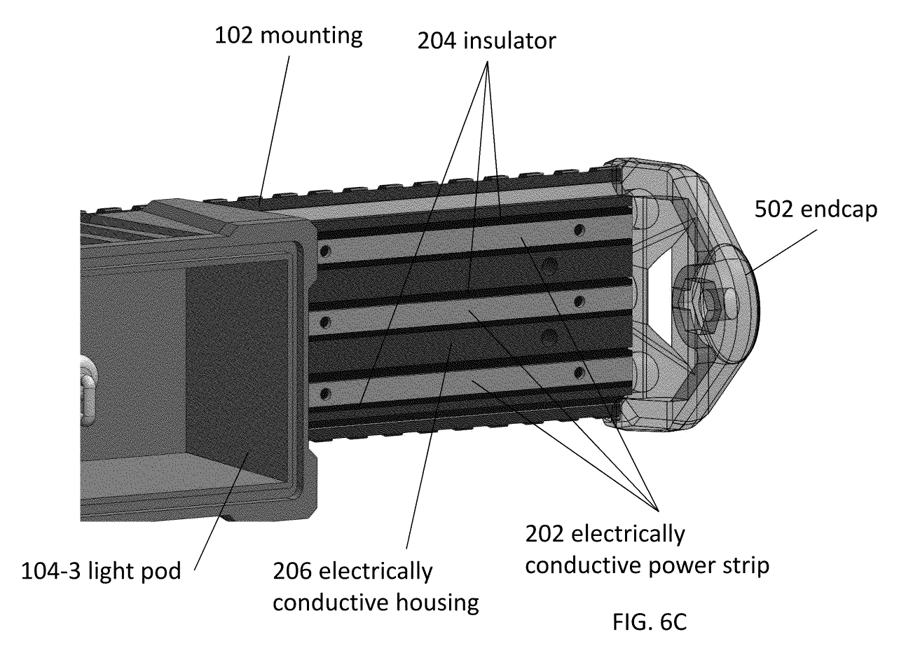

FIGS. 6A-6C are close up views of an example embodiment similar to that shown in FIGS. 5A-5B. FIG. 6A is a view of an example embodiment with multiple power strips 202 and a light pod 104-3 in place. FIG. 6B is a view of an example embodiment with an end cap 502 removed from the mounting. FIG. 6C is a close view of an example embodiment with end cap 502 attached.

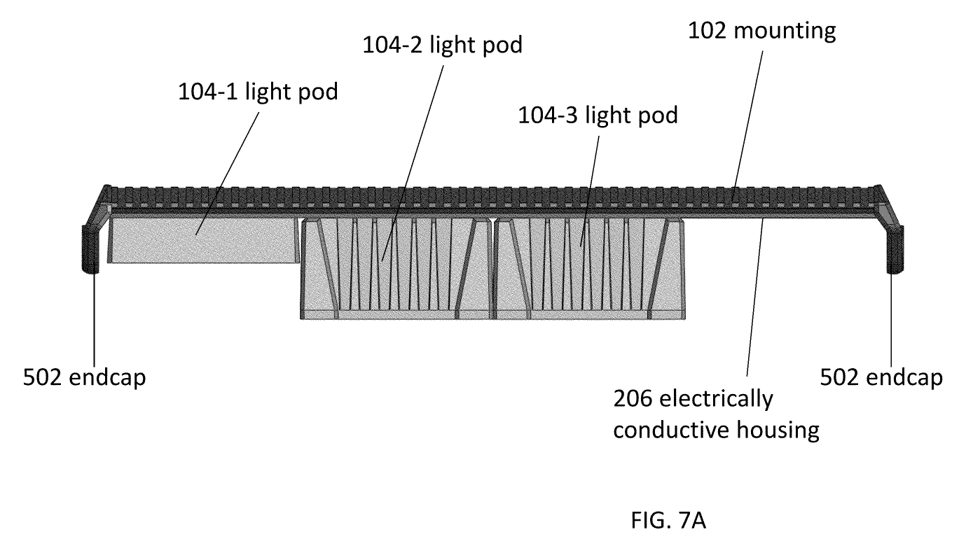

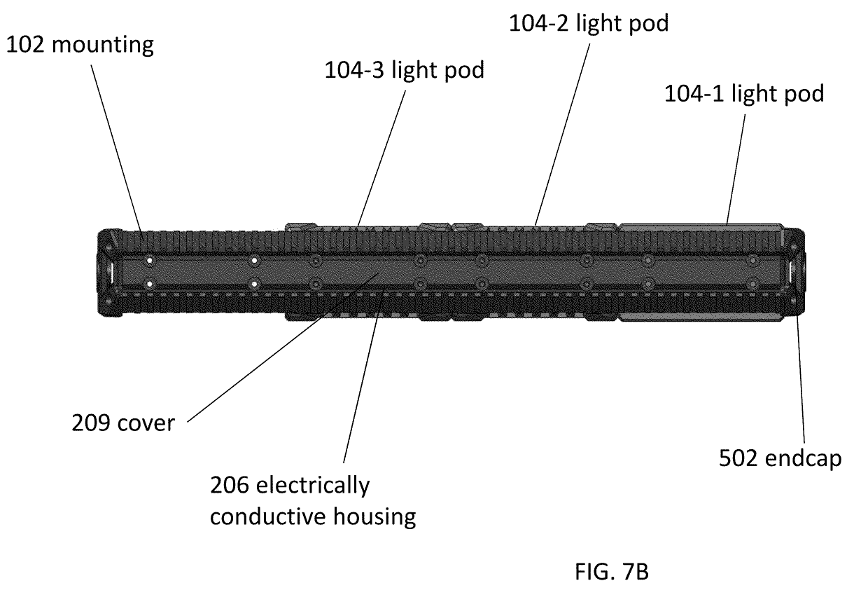

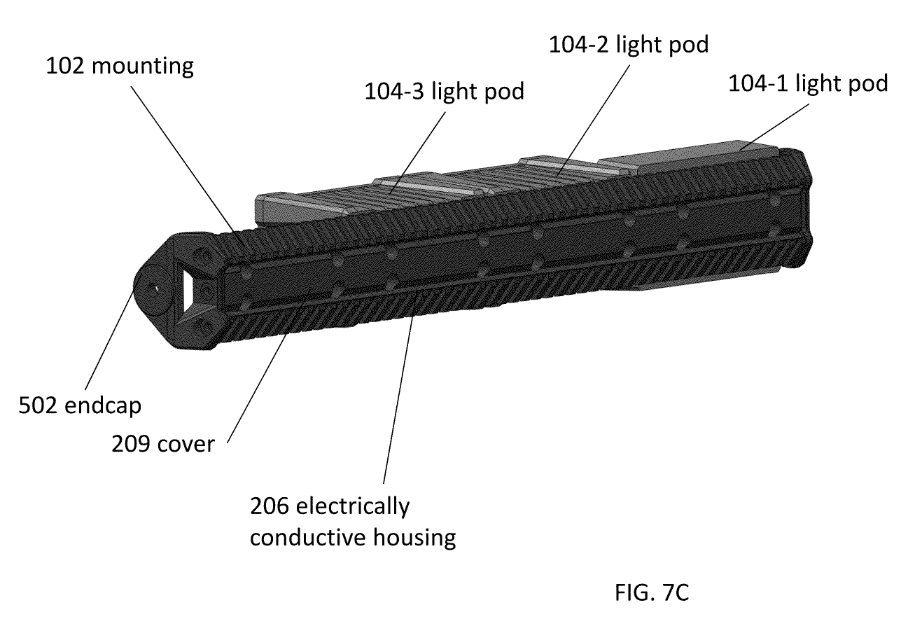

FIG. 7A is a top-down view of an example embodiment with different light pods. In the example embodiment, the varying depth of light pods 104-1, 104-2, and 104-3 can be seen. End caps 502 are shown extending from the sides of mounting 102 and can offer protection from contact or impacts from the sides of light pods 104.

FIG. 7B is a back view of an example embodiment. FIG. 7C is a rear perspective view of an example embodiment. FIGS. 7B-7C show the varied profiles of light pods 104. In the example embodiment, light pods 104 can be attached to mounting 102 using screws that pass through mounting 102 and into threaded screw holes provided in the back of each light pod 104. Other embodiments can have other attachment means. While only three light pods 104 are shown in FIGS. 5A-5B, 6A-6C, and 7A-7C with room for a fourth, any number of one or more light pods can be present. Also, a covering (not shown) can be used in such embodiments. This covering can protect the exposed electrically conductive power strips 202 from damage as well as protect unsuspecting users from harming themselves by contacting exposed electrically conductive surfaces. The covering can be held in place by appropriate means including clips, fasteners or others.

In some embodiments, adjacent light pods can be attached to each other using clips, fasteners, or other appropriate components. Similarly, adjacent lenses can be attached or adjacent bezels can be attached in various embodiments.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A vehicular lighting device, comprising:
a housing for light pods;
one or more light pods operable to provide illumination;
at least one window operable to protect the front of the light pod and allow light from within the light pod to illuminate the area in front of the vehicular lighting device; and
a power strip within the housing configured to provide power to the one or more light pods.

2. The vehicular lighting device of claim 1, wherein the power strip is secured to the housing.

3. The vehicular lighting device of claim 2, wherein the device is adapted to supply power directly to the one or more light pods without a wire.

4. The vehicular lighting device of claim 2, wherein the power strip runs lengthwise along the housing in a position opposite a power connection for each of the one or more light pods.

5. The vehicular lighting device of claim 4, further comprising a connector for each light pod that connects the power connection to the power strip.

6. The vehicular lighting device of claim 5, wherein the connector functions as both an electrical connection and a primary mechanical connection of the light pod to the housing.

7. The vehicular lighting device of claim 1, further comprising a bezel.

8. The vehicular lighting device of claim 1, wherein the housing is electrically conductive, the device further comprising an insulator between the power strip and the housing.

9. The vehicular lighting device of claim 1, wherein each of the one or more light pods comprises:
a printed circuit board having circuitry thereon;
at least one LED in electrical communication with the printed circuit board; and
a reflector operable to reflect light from the at least one LED.

10. A method of manufacturing a vehicular light bar, comprising:
coupling at least one light pod to a power strip of a housing;
wherein the power strip of the housing is capable of providing power to the at least one light pod, wherein the at least one light pod is operable to provide illumination, and wherein at least one window protects the front of the light pod and allows light from within the light pod to illuminate the area in front of the vehicular light bar.

11. The method of claim 10, wherein the housing comprises an electrical connection, the method further comprising:
securing the power strip to the housing with an insulator located therebetween.

12. The method of claim 11, wherein the power strip is secured such that it runs lengthwise along the housing in a position opposite a power connection for each of the one or more light pods.

13. The method of claim 10, wherein coupling the at least one light pod to the power strip comprises securing the at least one light pod to the power strip with a connector that further functions as an electrical connector that supplies power from the power strip to the at least one light pod.

14. The method of claim 13, wherein no wire is connected between the power strip and the at least one light pod.

15. The method of claim 10, further comprising attaching the window with a bezel.

16. The method of claim 10, further comprising:
coupling a printed circuit board having circuitry thereon and at least one LED in electrical communication with the printed circuit board with a reflector operable to reflect light from the at least one LED to form a light pod.

17. The method of claim 10, further comprising coupling a plurality of light pods to the power strip.

18. The method of claim 10, further comprising:
coupling a second light pod to the power strip of the housing;
wherein the power strip of the housing is capable of providing power to the second light pod, wherein the second light pod is operable to provide illumination, and wherein at least one window protects the front of the second light pod and allows light from within the second light pod to illuminate the area in front of the vehicular light bar.

19. The method of claim 18, wherein a front surface of the first and second light pods extend different distances from the power strip.
